(19) United States
(12) Patent Application Publication
(10) Pub. No.: US 2025/0145410 A1
(43) Pub. Date: May 8, 2025

(54) PROCESSING A USER REQUEST VIA A CONTROL SYSTEM OF AN ELEVATOR SYSTEM AND EXCHANGING DATA BETWEEN A MOBILE DEVICE AND A CONTROL SYSTEM OF AN ELEVATOR SYSTEM

(71) Applicant: Inventio AG, Hergiswil (CH)

(72) Inventor: Claudio Colombano, Beckenried (CH)

(21) Appl. No.: 18/835,371

(22) PCT Filed: Feb. 2, 2023
(86) PCT No.: PCT/EP2023/052539

§ 371 Date: Aug. 2, 2024

(30) Foreign Application Priority Data
Feb. 9, 2022 (EP) 22155760.6

(51) Int. Cl. B66B 1/46

(52) U.S. Cl. CPC B66B 1/468; B66B 2201/232; B66B 2201/4638; B66B 2201/4653

(57) ABSTRACT

A method for processing a user request via a control system of an elevator system comprising: receiving the user request in the control system; generating an identifier via the control system that enables a positive identification of the user request; sending the identifier from the control system to a mobile device associated with the user request, the mobile device configured to receive the identifier and to send an acknowledgment confirming receipt of the identifier in the mobile device to the control system when the mobile device receives a detection signal emitted by a transmitter attached to an elevator car of the elevator system; and when the acknowledgment is received in the control system assigning the user request to a first category or to a second category.

### FIELD

The present invention relates to a method for processing a user request via a control system of an elevator system and to a control system for carrying out the method. The invention further relates to a method for exchanging data between a mobile device and a control system of an elevator system and to a mobile device for carrying out the method. The invention also relates to a computer program and computer-readable medium for carrying out one or both of the methods and to a corresponding elevator system.

### BACKGROUND

Elevator cars of elevator systems, as can be used to transport people or goods in multi-floor buildings, are usually operated via control buttons which can be located in the elevator car and/or building.

There are also contactless operating concepts, where a call can be transmitted in a contactless manner, i.e., via a wireless data communication connection, via a mobile device connected to a central control device, such as a smartphone or tablet. In this connection, it is important to check whether such a call is in fact a call made by a user inside the building in which the elevator system in question is installed, or to identify whether the call was generated, for example, by a hacker outside the building, which could potentially interfere with the operation of the elevator system. For example, a QR code can be placed on each floor to enable a determination of the user's exact location. However, these codes can be easily reproduced.

### SUMMARY

Therefore, there may be a need for a method for processing a user request via a control system of an elevator system that enables a secure and technically simple distinction to be made between genuine user requests generated by actual users of the elevator system and possibly fake user requests. Therefore, there may be a need for a corresponding control system, a corresponding method for exchanging data between the control system and a mobile device, a corresponding mobile device, a corresponding elevator system, a corresponding computer program and a corresponding computer-readable medium.

These needs can be met by the subject matter of the advantageous embodiments defined in the following description, as well as the accompanying drawings.

A first aspect of the invention relates to a computer-implemented method for processing a user request via a control system of an elevator system, wherein the elevator system comprises at least one elevator car movable in an elevator shaft between different floors and the elevator car comprises at least one transmitter for emitting a detection signal, wherein the method comprises: receiving the user request in the control system; generating an identifier, which enables a positive identification of the user request, via the control system; sending the identifier from the control system to a mobile device associated with the user request, wherein the mobile device is configured to receive the identifier from the control system and to send an acknowledgment of receipt confirming receipt of the identifier in the mobile device to the control system when the mobile device receives the detection signal; when the acknowledgment of receipt is received in the control system: assigning the user request to a first category; otherwise: assigning the user request to a second category.

The method can be carried out automatically by one or more processors of the control system.

The transmitter can be attached to the elevator car so that it can be moved together with the elevator car in the elevator shaft. The transmitter can be located inside and/or outside the elevator car. The detection signal can, for example, encode an ID of the transmitter. The transmitter can be configured to emit the detection signal with a specific signal strength and/or at specific transmission intervals. In addition, the transmitter can be configured to receive signals, for example from the control system and/or from the mobile device. If the elevator system comprises a plurality of elevator cars, each of the elevator cars can, for example, comprise at least one separate transmitter. In addition, one or more such transmitters can be located in places other than the elevator cars, for example in the elevator shaft or in the area of a doorway through which the elevator car is accessible from one of the floors.

In principle, user requests of different categories can differ in how they are processed or handled by the control system. For example, the first category may comprise “wanted,” “permissible” or “genuine” user requests, whereas the second category can comprise “unwanted,” “impermissible” or “false” user requests.

The identifier can be a random code or a cookie, for example.

The confirmation of receipt can, for example, comprise the identifier itself. The confirmation of receipt can be sent directly from the mobile device to the control system. Alternatively, the confirmation of receipt can be sent from the mobile device to the control system via the transmitter.

The approach described above and below makes it possible to reliably identify and, if necessary, trace impermissible calls requesting an elevator car. In principle, the approach is based on the fact that the mobile device sending a call to the elevator control system via a wireless data communication connection is requested to prove its location, more precisely to prove that it is located within the elevator system, for example within an elevator shaft and/or an elevator car of the elevator system. This verification should be provided within a defined time window and can, for example, be triggered automatically based on detection of the mobile device, for example when the user enters the elevator car and the mobile device carried by the user is therefore within range of the elevator car's transmitter, i.e., can receive and process the detection signal.

This means, for example, that wanted calls can be distinguished from unwanted calls. The latter can, for example, be continuously saved and updated in a corresponding list, which enables a tracking of these calls. In this way, for example, it is possible to detect in good time when a very large number of such calls are received, which could lead to congestion of the elevator system's data communication network and could thus impair its proper operation. This means that appropriate countermeasures can be taken in good time, for example by at least temporarily deactivating and/or ignoring further user requests from the user or mobile device in question. Various escalation levels can be used here.

It is not obligatory to prevent all unwanted calls, i.e., some unwanted calls may also be tolerated, at least temporarily as long as undisturbed operation of the elevator system can be guaranteed. This can reduce the costs of implementing the method in hardware.

It is advantageous that the data communication network does not have to cover the entire building, in particular not all floors of the building, for such authentication of users, but merely requires the installation of suitable transmitters in a few selected sections of the building, namely the elevator cars. The number of elevator cars is normally much lower than the number of floors that the elevator cars travel to. This can significantly reduce installation costs compared to conventional concepts, which require very large coverage.

A second aspect of the invention relates to a computer-implemented method for exchanging data between a mobile device and a control system of an elevator system, wherein the elevator system comprises at least one elevator car movable in an elevator shaft between different floors, and the elevator car comprises at least one transmitter for emitting a detection signal, wherein the method comprises: generating a user request via the mobile device; sending the user request from the mobile device to the control system, wherein the control system is configured to receive the user request from the mobile device, to generate an identifier, which enables a positive identification of the user request, and to send the identifier to the mobile device associated with the user request; receiving the identifier in the mobile device; when the detection signal is received in the mobile device: sending a confirmation of receipt, which confirms the receipt of the identifier in the mobile device, from the mobile device to the control system.

The control system can be configured to process the user request in a method for processing a user request, as described above and below.

The method can be carried out automatically by a processor on the mobile device.

The method enables a secure identification of the mobile device as the device of a user who is actually located at the elevator system.

The mobile device can, for example, automatically generate the confirmation of receipt and/or send it to the control system. Alternatively, in response to receiving the detection signal, the mobile device can first automatically generate a prompt that prompts the user of the mobile device to make an entry. The mobile device can then generate the confirmation of receipt in response to the user's input and/or send it to the control system. In that case, the confirmation of receipt can hence only be sent as a result of interaction with the user (who is on site). The security of the method can thus be further increased.

A third aspect of the invention relates to a control system comprising a processor configured to carry out the method described above and below for processing a user request via a control system of an elevator system. Features of the control system can also be interpreted as features of this method, and vice versa.

For example, the control system can comprise a central server that can receive and process user requests of different mobile devices. For example, the server can be configured to forward the user requests to a local control device of the elevator for controlling actuators of the respective elevator system, wherein the control device can also be a component of the control system and can be connected to the server for data communication, for example via the Internet.

It is possible for the server to communicate simultaneously with the control devices of different elevator systems at different locations.

For example, the server can generate control signals directly from the user requests and forward them to the corresponding control device, which then converts the control signals accordingly.

Alternatively, the server can be configured to forward the user requests to the corresponding control device. Forwarding can take place as a function of the respective user request category. However, the user requests can also be received directly by the control device, i.e., without going through the server first.

Data communication between the server and the mobile device or devices can also take place via the Internet, for example.

A fourth aspect of the invention relates to a mobile device comprising a processor configured to carry out the method described above and below for exchanging data between a mobile device and a control system of an elevator system. Features of the mobile device can also be interpreted as features of this method, and vice versa.

A mobile device can be understood to mean a portable device having a processor, such as a smartphone, tablet, laptop or smartwatch. A special application can run on the mobile device, which is executed by the processor of the mobile device and enables the carrying out of the method for exchanging data described above and below.

The mobile device can be connected to the control system and/or the transmitter wirelessly, for example via WLAN, Bluetooth and/or mobile radio, and/or via the Internet for data communication.

The control system and the mobile device can each comprise hardware and/or software modules. In addition to the processor, the control system and the mobile device can each comprise a memory and data communication interfaces for data communication with peripheral devices.

A fifth aspect of the invention relates to an elevator system. The elevator system comprises: an elevator shaft; at least one elevator car which is movable in the elevator shaft between different floors and comprises at least one transmitter for emitting a detection signal; the control system as described above and below; and at least one mobile device as described above and below.

Further aspects of the invention relate to a computer program and a computer-readable medium in which the computer program is stored.

The computer program comprises commands which cause a processor to carry out at least one of the methods described above and below when the computer program is executed by the processor.

The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the methods described above and below can also be interpreted as features of the computer program and/or of the computer-readable medium, and vice versa.

Without restricting the scope of the invention in any way, embodiments of the invention may be considered to be based on the concepts and findings described below.

According to one embodiment, the method for processing the user request can further comprise: storing the second category user request in a monitoring list; if the monitoring list exceeds a certain number of entries within a certain monitoring period: ignoring at least temporarily future user requests that are associated with the same mobile device as the entries in the monitoring list. This means that congestion of the data communication network in which the control system is connected to the mobile device or devices can be avoided without completely blocking unwanted user requests from the outset.

According to one embodiment, the user request can be assigned to the first category only if the acknowledgment of receipt is received within a certain waiting period from a certain point in time when the identifier was generated. This can avoid the control system having to wait continuously for various acknowledgments of receipt, which may be associated with increased computing effort. Thus, this can also increase the security of the method against unauthorized access. The waiting period can, for example, be less than 1 hour, in particular less than 10 minutes, preferably less than 1 minute.

According to one embodiment, the user request can comprise position data indicating a current location of the mobile device. The position data can then also be evaluated to assign the user request. The position data may, for example, have been determined by a position sensor, which can be part of the mobile device, for example using a global navigation satellite system such as GPS or GLONASS. It is possible for the position data to be compared with reference data that indicates potential plausible locations of the mobile device in relation to the elevator system. If the position data indicates a plausible location, but a confirmation of receipt is not received at all or is not received in good time, it is quite likely that the user request does not originate from an actual user of the elevator system, i.e., one who is on site. It is also conceivable for the user request to be identified as coming from an actual user only if the position data indicates a plausible location and the confirmation of receipt is received (in good time). The position data can thus be used for plausibility checks when categorizing the user request. The reliability of the method can thus be increased.

According to one embodiment, the method for processing the user request can further comprise: generating a control signal for controlling actuators of the elevator system on the basis of the user request, so that the elevator car is moved from a starting floor to a destination floor, wherein the user request defines the starting floor and/or the destination floor. For example, the user can select the starting floor and/or the destination floor in an application running on their mobile device (see also above). The user request generated by the application can then contain corresponding information about the selected starting or destination floor. This embodiment enables the implementation of a contactless elevator system control via the mobile device.

If the elevator system comprises a plurality of elevator cars, the method can further comprise a step of selecting an elevator car from the plurality of elevator cars, wherein the control signal can be generated to move the selected elevator car from its current position to the starting floor and/or from the starting floor to the destination floor.

It is possible for the control signal to be generated even before the time from which the acknowledgment of receipt is waited for. This means that the elevator car can be moved in accordance with the desired destination floor even before the acknowledgment of receipt is received.

According to one embodiment, the transmitter can be configured to emit the detection signal within a defined range of not more than 10 m, preferably not more than 1 m. This can ensure that the mobile device will receive the detection signal only if in the elevator car or in the immediate vicinity of the elevator car.

According to one embodiment, the transmitter can be a Bluetooth transmitter, an RFID transmitter or an ultra-wideband transmitter. Such a transmitter can be provided in a particularly cost-effective manner and is easy to install.

Advantageous embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to one embodiment of the invention.

FIG. 2 shows a flowchart for a method according to one embodiment of the invention.

The drawings are merely schematic, and not to scale. Like reference signs refer in different drawings to like or analogous features.

### DETAILED DESCRIPTION

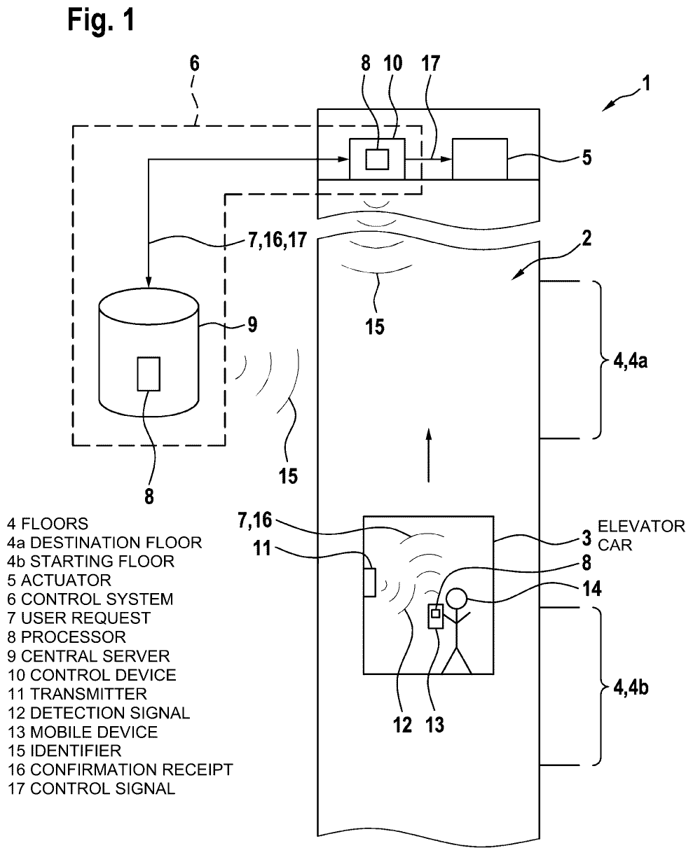

FIG. 1 shows an elevator system 1 with an elevator shaft 2 in which an elevator car 3 can be moved between a plurality of floors 4 by means of actuators 5. The actuators 5, which can comprise an electric motor, are controllable via a control system 6 configured to process a user request 7.

The method can be carried out by a processor 8 of the control system 6, wherein the processor 8 can be part of a central server 9 and/or of a control device 10 of the control system 6.

The control device 10 can, for example, be part of the same elevator system 1 as the actuators 5, whereas the server 9 can be connected to the control devices 10 of different elevator systems 1 at different locations for data communication, for example via the Internet.

A transmitter 11 is attached to the elevator car 3, here in the elevator car 3, which transmitter is movable together with the elevator car 3 in the elevator shaft 2 and is configured to emit a detection signal 12. The elevator car 3 can also comprise a plurality of transmitters 11, which can be attached at different points on the elevator car 3.

The transmitter 11 can emit the detection signal 12, for example, with a certain signal strength that is defined such that the detection signal 12 can be received by a mobile device 13, such as a smartphone or tablet, within a radius of not more than 10 m, preferably not more than 1 m, from the transmitter 11.

The transmitter 11 can be designed, for example, as a Bluetooth, RFID or ultra-wideband transmitter or as a combination of at least two of these examples.

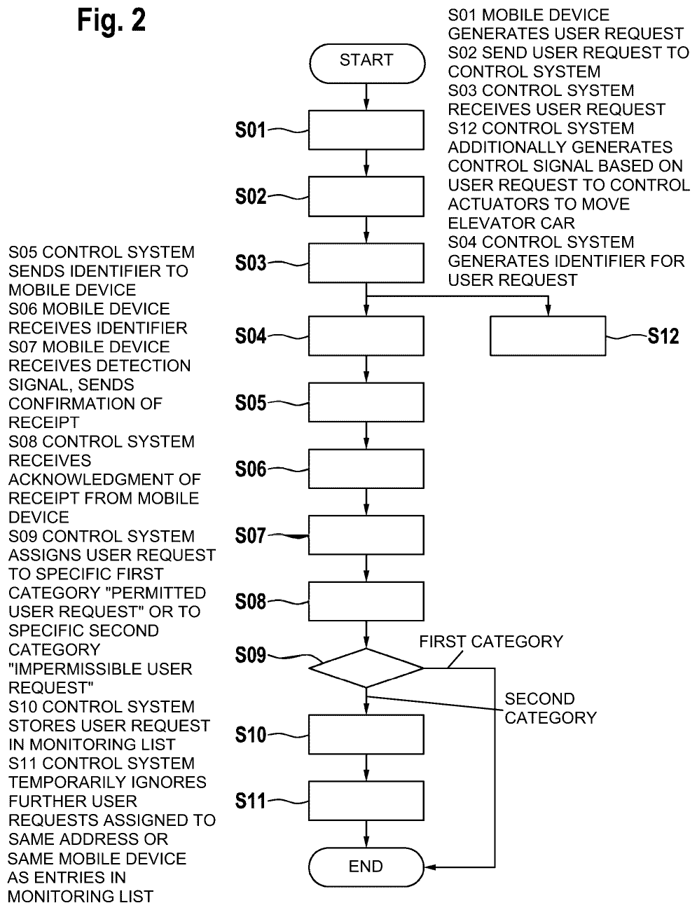

The user request 7 is normally generated by a mobile device 13, which is carried by a user 14 of the elevator system 1 and on which a special application for contactless control of the elevator system 1 can run. The application can be executed by a processor 8 of the mobile device 13. A user 14 wishing to use the elevator system 1 is normally located in the immediate vicinity of the elevator system 1. In some cases, however, the user request 7 can be generated improperly by a remote third-party device, for example during a hacker attack or the like. In order to distinguish such unwanted user requests from genuine user requests, the method described below can be carried out (see FIG. 2) by the processor 8 of the mobile device 13 or of the control system 6 executing a corresponding computer program.

In that case, the mobile device 13 generates the user request 7 in a step S01 and sends it to the control system 6 in a step S02.

The user request 7 can, for example, display a destination floor 4a requested by the user 14. In addition, the user request 7 can indicate a starting floor 4b on which the user 14 is currently located or from where the user 14 would like to be taken to the destination floor 4a.

The user request 7 can also comprise an address from which the user request 7 was sent in a data communication network in which the mobile device 13 and the control system 6 are connected to each other, such as the Internet.

In addition, the user request 7 can comprise position data indicating a current location of the mobile device 13. The position data can be, for example, geographical coordinates of the mobile device 13.

The control system 6 receives the user request 7 from the mobile device 13 in a step S03. The user request 7 can be received by the server 9 and/or by the control device 10.

The control system 6 generates an identifier 15 for the user request 7 in a step S04. The identifier 15 enables a positive identification of the user request 7, i.e., for positively distinguishing between a user request 7 and any other user requests received in the control system 6.

In a step S05, the control system 6 sends the identifier 15 back to the mobile device 13 assigned to the user request 7.

In a step S06, the mobile device 13 receives the identifier 15 from the control system 6. The identifier 15 can be stored locally in the mobile device 13.

If the mobile device 13 is within range of the transmitter 11, for example because the user 14 carrying the mobile device 13 has entered the elevator car 3, the mobile device 13 can receive the detection signal 12 in a step S07. Only then does the mobile device 13 send a confirmation of receipt 16, which confirms receipt of the identifier 15 in the mobile device 13, back to the control system 6.

The control system 6 receives the acknowledgment of receipt 16 from the mobile device 13 in a step S08.

In a step S09, the control system 6 assigns the user request 7 to a specific first category in response to the (timely) receipt of the acknowledgment of receipt 16, here for example to the “permitted user request” category.

However, if the control system 6 had not received a confirmation of receipt 16 for the user request 7, for example because the mobile device 13 assigned to the user request 7 is not in the immediate vicinity of the transmitter 11, in particular not in the elevator car 3, the control system 6 would have assigned the user request 7 to a specific second category in the step S09, in this case for example the “impermissible user request” category.

Conveniently, it is possible for the user request 7 to be assigned to the first category only if the acknowledgment of receipt 16 is received within a limited waiting period from a certain point in time when the identifier 15 was generated in the step S04. The waiting period can, for example, be not more than 1 hour, in particular not more than 10 minutes, preferably not more than 1 minute.

The position data can also be evaluated to assign the user request 7 in the step S09.

If the user request 7 is categorized as an “impermissible user request,” the control system 6 can store the user request 7 in a monitoring list in an additional step S10.

If the monitoring list exceeds a certain number of entries, for example 10, 100 or 1000, within a certain monitoring period, for example 1 hour, 10 minutes, 1 minute or 1 second, the control system 6 can, in an additional step S11, at least temporarily ignore further user requests assigned to the same address or the same mobile device 13 as the entries in the monitoring list. Thus, congestion of the data communication network of the elevator system 1, for example between the server 9 and the control device 10, between the server 9 and the mobile device 13 (or mobile devices 13), or between the control device 10 and the mobile device 13 (or mobile devices 13), can be avoided.

In a step S12, which can be carried out even before the step S09, the control system 6 can additionally generate a control signal 17 on the basis of the user request 7, which is used to control the actuators 5 so that the elevator car 3 moves from the starting floor 4b to the destination floor 4a. This means that the confirmation of receipt 16 can be sent by the mobile device 13 or received in the control system 6 not earlier than during the journey.

An exemplary procedure of the method is summarized below in other words.
1) The user 14 opens the application (which is registered with a specific unique ID) on their mobile device 13 and makes a destination call, wherein a corresponding user request 7 is generated and sent.
2) A cloud application running on the server 9 grants the destination call and sends back a positive confirmation together with the identifier 15 that uniquely identifies the destination call.
3) The server 9 notifies the control device 10 to execute the destination call and assign the identifier 15 to the elevator car 3 selected for the destination call (or to all elevator cars 3 if the elevator car 3 designated for the destination call is selected dynamically on site).
4) The selected elevator car 3 stops at the starting floor 4b and the user 14 enters it.
5) While traveling to the destination floor 4a, the transmitter 11 of the elevator car 3 requests the mobile device 13 (carried by the user 14) to send the confirmation of receipt 16 to the control system 6.
6) If the identifier 15 contained in the acknowledgment of receipt 16 is correct, the destination call is recognized as valid.
7) If the request remains unanswered, the destination call is marked as potentially invalid.

The server 9 can inform the control device 10 about potentially invalid destination calls, and vice versa.

When a certain number of potentially invalid destination calls per time unit originating from the same mobile device 13 is reached, the control device 10 can inform the server 9 (or vice versa) so that corresponding user requests 7 from the mobile device 13 concerned are temporarily deactivated.

Finally, it should be noted that terms such as “having,” “comprising,” etc. do not exclude other elements or steps, and indefinite articles such as “a” or “an” do not exclude a plurality. Furthermore, it is noted that features or steps described with reference to one of the preceding embodiments can also be used in combination with features or steps described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method for processing a user request by a control system of an elevator system, wherein the elevator system includes an elevator car movable in an elevator shaft between different floors, and the elevator car has a transmitter emitting a detection signal, wherein the method comprises the steps of:
receiving the user request in the control system;
generating an identifier by the control system, the identifier enabling a positive identification of the user request;
sending the identifier from the control system to a mobile device associated with the user request, wherein the mobile device is adapted to receive the identifier from the control system and to send an acknowledgment of receipt confirming receipt of the identifier in the mobile device to the control system when the mobile device receives the detection signal;
when the acknowledgment of receipt is received in the control system, the control system assigns the user request to a first category; and
when the acknowledgment of receipt is not received in the control system, the control system assigns the user request to a second category.

15. The method according to claim 14 including:
storing the user request assigned to the second category in a monitoring list; and
when the monitoring list exceeds a predetermined number of the stored user requests within a predetermined monitoring period, ignoring at least temporarily future user requests that are associated with a same mobile device as the stored user requests in the monitoring list.

16. The method according to claim 14 wherein the user request is assigned to the first category only when the acknowledgment of receipt is received in the control system within a predetermined waiting period from a time when the identifier was generated.

17. The method according to claim 14 wherein the user request includes position data indicating a current location of the mobile device, and wherein the control system evaluates the position data is also evaluated to assign the user request.

18. The method according to claim 14 including generating from the control system a control signal for controlling actuators of the elevator system based on the user request so that the actuators move the elevator car a starting floor to a destination floor, wherein the user request defines the starting floor and/or the destination floor.

19. A control system including a processor adapted to carry out associated ones of the steps of the method according to claim 14.

20. An elevator system comprising:
an elevator shaft;
an elevator car movable in the elevator shaft between different floors and having a transmitter emitting a detection signal; and
a control system and a mobile device, each of the control system and the mobile device having a processor adapted to carry out associated ones of the steps of the method according to claim 14.

21. The elevator system according to claim 20 wherein the transmitter emits the detection signal within a predetermined range of not more than 10 m.

22. The elevator system according to claim 21 wherein the predetermined range is not more than 1 m.

23. The elevator system according to claim 20 wherein the transmitter is a Bluetooth transmitter, an RFID transmitter or an ultra-wideband transmitter.

24. A computer program product comprising commands that when executed by processors of the control system and the mobile device, cause the control system and the mobile device to carry out the method according to claim 14.

25. A non-transitory computer-readable medium on which the computer program product according to claim 24 is stored.

26. A method for exchanging data between a mobile device and a control system of an elevator system, wherein the elevator system includes an elevator car movable in an elevator shaft between different floors, and the elevator car has a transmitter emitting a detection signal, wherein the method comprises the steps of:
generating a user request by the mobile device;
sending the user request from the mobile device to the control system, wherein the control system is adapted to receive the user request from the mobile device, to generate an identifier that enables a positive identification of the user request, and to send the identifier to the mobile device associated with the user request;
receiving the identifier in the mobile device; and
when the detection signal is received in the mobile device, sending a confirmation of receipt by the mobile device, the confirmation of receipt confirming the receipt of the identifier in the mobile device, from the mobile device to the control system.

27. A mobile device including a processor adapted to carry out associated ones of the steps of the method according to claim 26.

28. An elevator system comprising:
an elevator shaft;
an elevator car movable in the elevator shaft between different floors and having a transmitter emitting a detection signal; and
a control system and a mobile device, each of the control system and the mobile device having a processor adapted to carry out associated ones of the steps of the method according to claim 26.

29. The elevator system according to claim 28 wherein the transmitter emits the detection signal within a predetermined range of not more than 10 m.

30. The elevator system according to claim 29 wherein the predetermined range is not more than 1 m.

31. The elevator system according to claim 28 wherein the transmitter is a Bluetooth transmitter, an RFID transmitter or an ultra-wideband transmitter.

32. A computer program product comprising commands that when executed by a processor of an elevator control system, cause the control system to carry out the method according to claim 26.

33. A non-transitory computer-readable medium on which the computer program product according to claim 32 is stored.
